(19) United States
(12) Patent Application Publication
(10) Pub. No.: US 2025/0168651 A1
(43) Pub. Date: May 22, 2025

(54) COMMUNICATION METHOD

(71) Applicant: KYOCERA Corporation, Kyoto (JP)

(72) Inventors: Mitsutaka HATA, Yokohama-shi (JP); Masato FUJISHIRO, Yokohama-shi (JP); Shunsuke NITTA, Kawasaki-shi (JP)

(73) Assignee: KYOCERA Corporation, Kyoto (JP)

(21) Appl. No.: 19/030,412

(22) Filed: Jan. 17, 2025

Related U.S. Application Data
(63) Continuation of application No. PCT/JP2023/026456, filed on Jul. 19, 2023.

(30) Foreign Application Priority Data
Jul. 20, 2022 (JP) 2022-115293

(51) Int. Cl. H04W 16/18; H04W 24/02; H04W 24/10

(52) U.S. Cl. CPC H04W 16/18; H04W 24/02; H04W 24/10

(57) ABSTRACT

Provided is a communication method in a mobile communication system including a first user equipment, a second user equipment, and a network node capable of communicating with the first user equipment and the second user equipment, the mobile communication system being capable of deriving a first learned model using first learning data and deriving a second learned model using second learning data. The communication method includes associating, by any of the network node and the first user equipment, environment data indicating an environmental state of the first user equipment with first learning data.

### RELATED APPLICATIONS

The present application is a continuation based on PCT Application No. PCT/JP2023/026456, filed on Jul. 19, 2023, which claims the benefit of Japanese Patent Application No. 2022-115293 filed on Jul. 20, 2022. The content of which is incorporated by reference herein in their entirety.

### TECHNICAL FIELD

The present disclosure relates to a communication method.

### BACKGROUND

In recent years, in the Third Generation Partnership Project (3GPP) (trade name), which is a standardization project for mobile communication systems, a study is underway to apply an Artificial Intelligence (AI) technology, particularly, a Machine Learning (ML) technology to wireless communication (air interface) in the mobile communication system.

### CITATION LIST

### Non-Patent Literature

Non-Patent Document 1: 3GPP Contribution RP-213599, “New SI: Study on Artificial Intelligence (AI)/Machine Learning (ML) for NR Air Interface”

### SUMMARY

In an aspect, a communication method in a mobile communication system including a first user equipment, a second user equipment, and a base station capable of communicating with the first user equipment and the second user equipment, the mobile communication system being capable of deriving a first learned model using first learning data and deriving a second learned model using second learning data. The communication method includes associating, by any of the base station and the first user equipment, environment data indicating an environmental state of the first user equipment with first learning data.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a base station (gNB) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of the AI/ML technology according to the first embodiment.

FIG. 7 is a diagram illustrating an example of a first operation scenario according to the first embodiment.

FIG. 8 is a diagram illustrating a configuration example of the UE and the gNB according to the first embodiment.

FIG. 9 is a diagram illustrating a configuration example of the UE and the gNB according to the first embodiment.

FIG. 10 is a diagram illustrating an operation example of the first operation scenario according to the first embodiment.

FIG. 11 is a diagram illustrating an example of a second operation scenario according to the first embodiment.

FIG. 12 is a diagram illustrating a configuration example of the UE and the gNB according to the first embodiment.

FIG. 13 is a diagram illustrating a configuration example of the UE and the gNB according to the first embodiment.

FIG. 14 is a diagram illustrating an operation example of a second operation scenario according to the first embodiment.

FIG. 15 is a diagram illustrating a configuration example of the UE and the gNB according to the first embodiment.

FIG. 16 is a diagram illustrating a configuration example of the UE and the gNB according to the first embodiment.

FIG. 17 is a diagram illustrating a configuration example of the UE and the gNB according to the first embodiment.

FIG. 18 is a diagram illustrating a configuration example of the UE and the gNB according to the first embodiment.

### DESCRIPTION OF EMBODIMENTS

For applying a machine learning technology to a mobile communication system, how to leverage the machine learning technology has not yet been established.

In view of this, the present disclosure is to enable the machine learning technology to be appropriately leveraged in the mobile communication system.

### First Embodiment

A mobile communication system according to a first embodiment will be described with reference to the drawings. In the description of the drawings, the same or similar parts are denoted by the same or similar reference signs.

### Configuration of Mobile Communication System

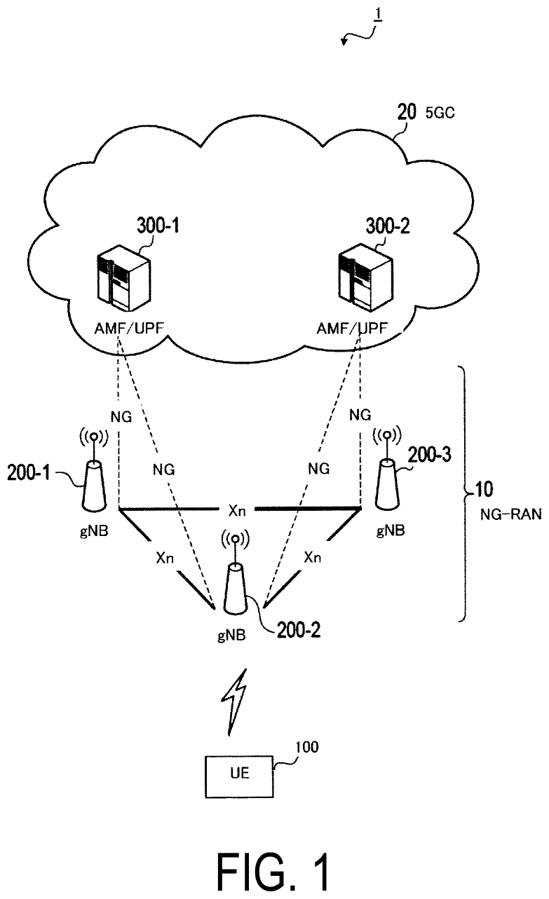

A configuration of a mobile communication system according to a first embodiment will be described. FIG. 1 is a diagram illustrating a configuration example of the mobile communication system according to the first embodiment. The mobile communication system 1 complies with the 5th Generation System (5GS) of the 3GPP standard. The description below takes the 5GS as an example, but a Long Term Evolution (LTE) system may be at least partially applied to the mobile communication system. A system of the sixth (6G) or subsequent generation system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

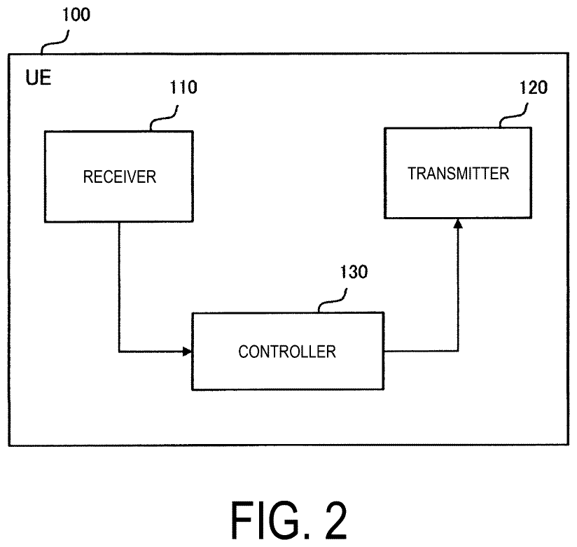

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

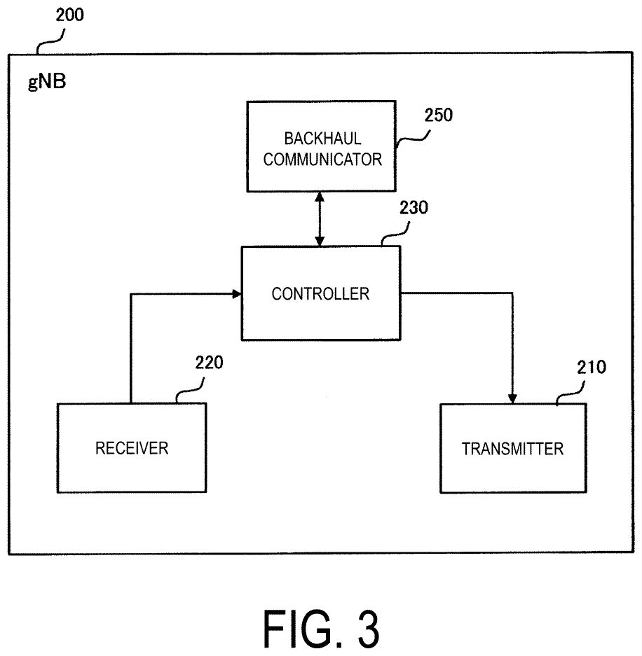

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

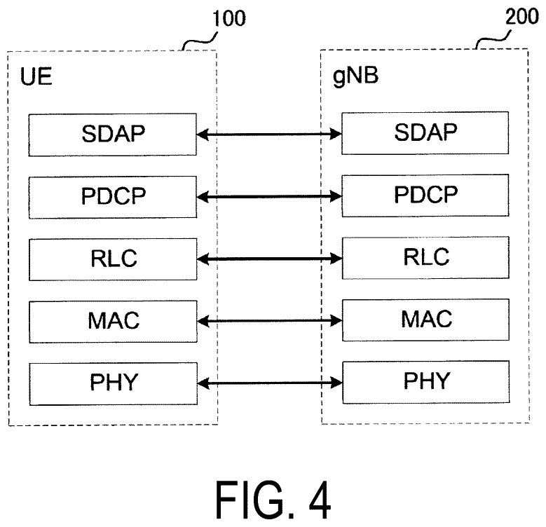

FIG. 4 is a diagram illustrating a configuration example of a protocol stack of a radio interface of a user plane handling data.

A radio interface protocol of the user plane includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and obtains successfully decoded DCI as DCI addressed to the UE 100. The DCI transmitted from the gNB 200 is appended with CRC parity bits scrambled by the RNTI.

In the NR, the UE 100 may use a bandwidth that is narrower than a system bandwidth (i.e., a bandwidth of the cell). The gNB 200 configures a bandwidth part (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by control in the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on the serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an access stratum (AS). Note that, when the RAN is connected to the EPC, the SDAP need not be provided.

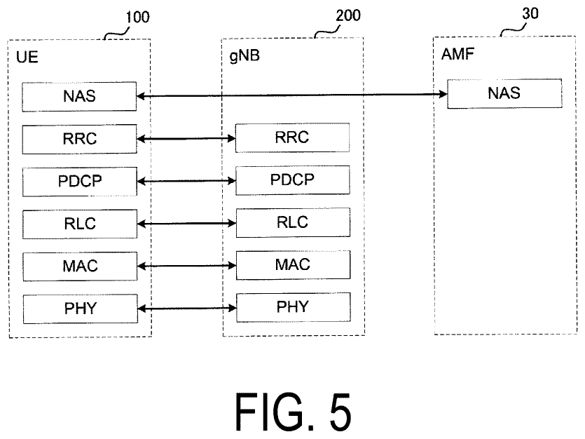

FIG. 5 is a diagram illustrating a configuration of a protocol stack of a radio interface of a control plane handling signaling (a control signal).

The protocol stack of the radio interface of the control plane includes a radio resource control (RRC) layer and a non-access stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300A. Note that the UE 100 includes an application layer other than the protocol of the radio interface. A layer lower than the NAS is referred to as Access Stratum (AS).

### AI/ML Technology

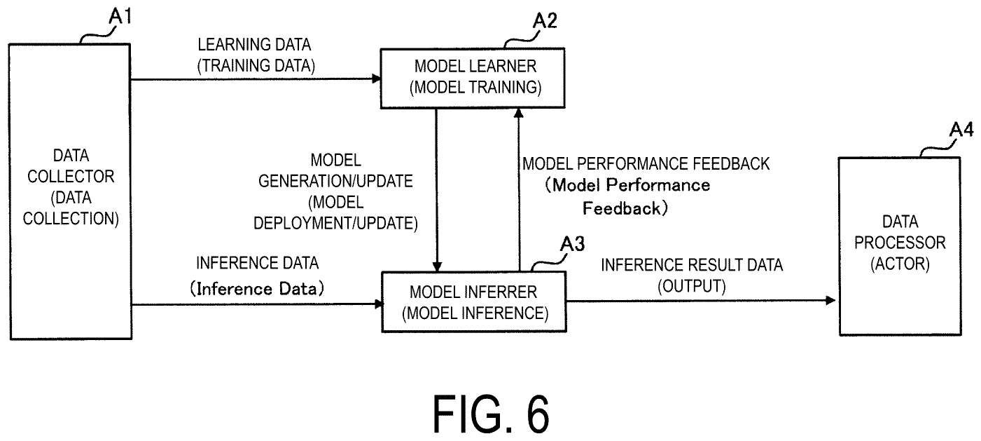

In the embodiment, an AI/ML Technology will be described. FIG. 6 is a diagram illustrating a configuration example of functional blocks of the AI/ML technology in the mobile communication system 1 according to the first embodiment.

An example of the block configuration of the functions illustrated in FIG. 6 includes a data collector A1, a model learner A2, a model inferrer A3, and a data processor A4.

The data collector A1 collects input data, specifically, learning data and inference data. The data collector A1 outputs the learning data to the model learner A2. The data collector A1 also outputs the inference data to the model inferrer A3. The data collector A1 may obtain, as the input data, data in an apparatus provided with the data collector A1 itself. The data collector A1 may obtain, as the input data, data in another apparatus.

The model learner A2 performs model learning. To be specific, the model learner A2 optimizes parameters for the learning model by machine learning using the learning data, and derives (generates or updates) a learned model. The model learner A2 outputs the derived learned model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. The supervised learning is a method of using correct answer data for the learning data. The unsupervised learning is a method of not using correct answer data for the learning data. For example, in the unsupervised learning, feature points are learned from a large amount of learning data, and correct answer determination (range estimation) is performed. The reinforcement learning is a method of assigning a score to an output result and learning a method of maximizing the score. Although the supervised learning will be described below, the unsupervised learning and/or reinforcement learning may be applied as the machine learning.

The model inferrer A3 performs model inference. To be specific, the model inferrer A3 infers an output from the inference data by using the learned model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a learned model. Here, various approaches for the model are used, such as linear regression analysis, neural network, and decision tree analysis. The above “y=ax+b” can be considered as a kind of the linear regression analysis. The model inferrer A3 may perform model performance feedback to the model learner A2.

The data processor A4 receives the inference result data and performs processing using the inference result data.

### Applied Example of First Embodiment

In the first embodiment, an example will be described in which a machine learning technology is applied to the mobile communication system 1. To be specific, two operation scenarios will be described. In other words, in one of the operation scenarios, the UE 100 performs model learning and model inference, and in the other operation scenario, the gNB 200 performs model learning and model inference.

In the operation scenario in which the UE 100 performs model learning and model inference, three operation scenarios will be described as examples. In other words, the operation scenarios include a first operation scenario using Channel State Information (CSI) feedback enhancement, a third operation scenario using Beam management, and a fourth operation scenario using Positioning accuracy enhancement.

On the other hand, in the operation scenario in which the gNB 200 performs model learning and model inference, an operation scenario (second operation scenario) will be described which is based on CSI feedback using a Sounding Reference Signal (SRS).

In order to avoid insufficient learning, the learner (UE 100 or gNB 200) may perform machine learning using a large amount of learning data. Thus, the learner may use learning data from sources other than the environment of the learner. For example, the UE 100-2 (learner) receives learning data used for machine learning in the UE 100-1 via the gNB 200 or the CN 20 and performs machine learning using the learning data.

In this case, when using learning data that is not applied to the environment of the learner, the learner performs incorrect machine learning. As a result, even a learned model derived by machine learning cannot be considered to be an appropriate learning model. Even if an inference result is obtained using the learned model obtained in this manner, the inference result may greatly deviate from the correct answer.

For example, it is assumed that the UE 100-2 (learner) is in a stationary environment and the learning data of the UE 100-1 is the learning data obtained when the UE 100-1 moves. In this case, when the UE 100-2 adopts the learning data of the UE 100-1, the accuracy rate of the inference result inferred from the learned model may decrease as compared with the case where the learning data is not adopted.

The first embodiment is intended to appropriately utilize the machine learning technology in the mobile communication system 1 by avoiding using, for machine learning, learning data that is not suitable for the environment of the learner.

### (1) First Operation Scenario

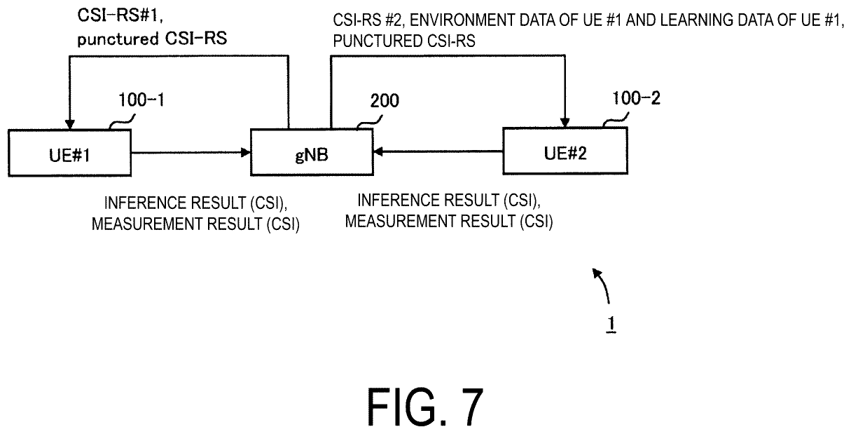

FIG. 7 is a diagram illustrating an example of the first operation scenario according to the first embodiment.

As illustrated in FIG. 7, the mobile communication system 1 in the first operation scenario includes the UE 100-1 (for example, the first user equipment) and the UE 100-2 (for example, the second user equipment), and a gNB 200 (for example, the base stations) capable of communicating with UE 100-1 and UE 100-2.

In the first operation scenario, the UE 100-1 (for example, first user equipment), performs machine learning using learning data (for example, first learning data) to derive a learned model (for example, a first learned model). In the first operation scenario, the UE 100-2 (for example, second user equipment) performs machine learning using learning data (for example, second learning data) to derive a learned model (for example, a second learned model).

In the first operation scenario, the UE 100-2 can derive the learned model (for example, the second learned model) using the learning data (for example, the first learning data) used when the UE 100-1 derives the learned model (for example, the first learned model).

At this time, in the first operation scenario, any of the gNB 200 (for example, the base station) and the UE 100-1 (for example, the first user equipment) associates environment data indicating an environmental state in the UE 100-1 with the learning data of the UE 100-1.

Such association enables the UE 100-2, having received the environment data of the UE 100-1 and the learning data of the UE 100-1, to determine whether to perform machine learning using the learning data of the UE 100-1 based on the environment data of the UE 100-1. As a result, the UE 100-2 can avoid using, for machine learning, learning data that is not suitable for the environment of the UE 100-2 (for example, the learning data of the UE 100-1), and the machine learning technology can be appropriately utilized in the mobile communication system 1.

### (1.1) Installation Example of Functional Blocks

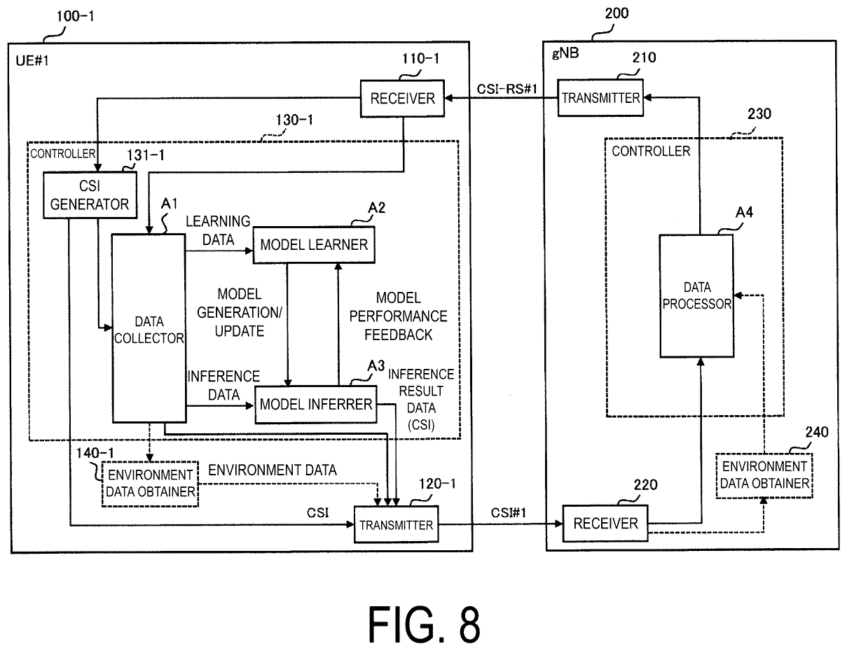

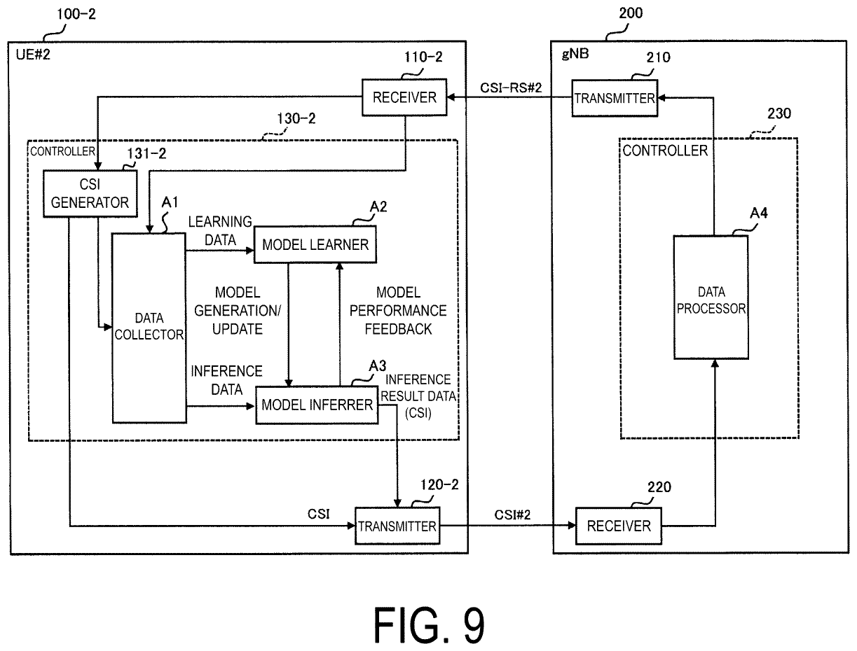

FIGS. 8 and 9 is a diagram illustrating a configuration example of the UEs 100-1 and 100-2 and the gNB 200 in the first operation scenario according to the first embodiment. As illustrated in FIGS. 8 and 9, in the first operation scenario, the data collector A1, the model learner A2, and the model inferrer A3 are installed in the UE 100-1 and 100-2 (for example, controllers 130-1 and 130-2). The data processor A4 is installed in the gNB 200 (for example, a controller 230). In other words, the UE 100 performs model learning and model inference.

In the first operation scenario, the machine learning technology is introduced into CSI feedback from the UE 100-1 and the UE 100-2 to the gNB 200. The CSI transmitted (fed back) from the UE 100-1 and the UE 100-2 to the gNB 200 is information indicating a downlink channel state between the UE 100-1 and the UE 100-2 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI.

The gNB 200 transmits a reference signal for the UE 100 to estimate a downlink channel state. Such a reference signal may be, for example, a CSI reference signal (CSI-RS) and/or a demodulation reference signal (DMRS). The description of the first operation scenario assumes that the reference signal is a CSI-RS.

First, in the model learning in the UE 100-1, a receiver 110-1 of the UE 100-1 receives the CSI-RS transmitted from the gNB 200 (hereinafter, the CSI-RS received by the UE 100-1 may be referred to as “CSI-RS #1”). A CSI generator 131-1 uses the CSI-RS #1 to perform channel estimation and generates CSI. The data collector A1 receives the CSI-RS #1 and the CSI generated in the CSI generator 131-1, and outputs the CSI-RS #1 and the CSI to the model learner A2 as the learning data. The model learner A2 derives a learned model (for example, the first learned model) using the learning data (CSI-RS #1 and CSI).

Second, in the model inference in the UE 100-1, the receiver 110-1 of the UE 100-1 receives the CSI-RS from the gNB 200 by using a resource that is less than that used to receive the CSI-RS #1. Hereinafter, such a CSI-RS may be referred to as a partial CSI-RS or a punctured CSI-RS. The model inferrer A3 uses the learned model to infer the CSI as inference result data from inference data including the partial CSI-RS.

The model learning in the UE 100-2 is basically the same as, and/or similar to, the model learning in the UE 100-1. The CSI-RS received by UE 100-2 may be referred to as “CSI-RS #2”. The CSI generator 131-2 of the UE 100-2 generates CSI from the CSI-RS #2. The data collector A1 outputs the CSI-RS #2 and the CSI generated from the CSI-RS #2 to the model learner A2 as the learning data. The model learner A2 performs machine learning by using the CSI-RS #2 and the CSI as the learning data to derive a learned model (for example, the second learned model).

The model inference in the UE 100-2 is basically the same as, and/or similar to, the model inference in the UE 100-1. The model inferrer A3 of the UE 100-2 performs model inference from the inference data including a partial CSI-RS and outputs the inference result data (CSI).

Note that the gNB 200 may transmit the partial CSI-RS by reducing the number of antenna ports with respect to full CSI-RSI that is not partial. Note that the antenna port is an example of the resource. The gNB 200 may transmit the partial CSI-RS by using a resource obtained by reducing a time-frequency resource with respect to the full CSI-RS.

As described above, the data collector A1, the model learner A2, the model inferrer A3, and the data processor A4 are installed in the UE 100-1, the UE 100-2, and the gNB 200.

### (1.2) Obtaining Environment Data

In the first operation scenario, an environment data obtainer 140-1 of the UE 100-1 can obtain the environment data indicating the environmental state of the UE 100-1. The environment data obtainer 140-1 may generate the environment data of the UE 100-1 in response to obtaining the learning data of the UE 100-1. The environment data is, for example, environment data obtained when the learning data is obtained in the UE 100-1. The environment data obtainer 140-1 can transmit the environment data of the UE 100-1 to the gNB 200 via a transmitter 120-1.

The environment data of the UE 100-1 may be obtained in the gNB 200. In this case, the environment data obtainer 240 of the gNB 200 can obtain the environment data of the UE 100-1 based on a reception signal received from the UE 100-1. For example, the environment data obtainer 240 may obtain the environment data based on measurement data or the like transmitted from the UE 100-1 using a function of Self-Organizing Networks (SON) and/or Minimization of Drive Tests (MDT). The SON is a technology for autonomously organizing or optimizing the network. By using the function of the SON, the gNB 200 can obtain the measurement data of the radio environment from the UE 100-1. The MDT is a technology for supporting collection of measurement values specific to the UE 100-1. For example, the gNB 200 can obtain, from the UE 100-1, measurement data collected through a drive test using an electric measuring vehicle. The environment data obtainer 240 of the gNB 200 may use the received power or the reception quality of the signal received from the UE 100-1 as the environment data.

When the environment data is obtained by the environment data obtainer 240 of the gNB 200, the UE 100-1 may transmit, to the gNB 200, an environmental condition request for requesting an environmental condition desired by the UE 100-1. The environmental condition indicates a condition that the UE 100-1 desires to use as environment data, such as an environment data in which a distance from the UE 100-1 is equal to or less than a distance threshold (or equal to or more than a distance threshold) or an environment data in which a movement speed of the UE 100-1 is equal to or less than a speed threshold (or equal to or more than a speed threshold). The UE 100-1 may include and transmit the environmental condition request in an RRC message, MAC control element (CE), or uplink control information (UCI). Based on the environmental condition request, the environment data obtainer 240 of the gNB 200 generates environment data that matches (or satisfies) the environmental condition. As described above, since the UE 100-1 can set the environment data that matches (or satisfies) the environmental condition, the environment data can be set in such a manner that the amount of the environment data is not excessively large.

(1.3) Associating Environment Data with Learning Data

In the first operation scenario, any of the UE 100-1 and gNB 200 can associate the environment data of the UE 100-1 with the learning data (for example, the first learning data) of the UE 100-1.

First, when the environment data obtainer 140-1 of the UE 100-1 obtains the environment data, the UE 100-1 may perform the association. In this case, for example, the environment data obtainer 140-1 obtains the learning data from the data collector A1 and generates environment data in response to obtaining the learning data. Then, the environment data obtainer 140-1 associates the environment data with the learning data. The environment data obtainer 140-1 transmits the learning data and the environment data to the gNB 200 via the transmitter 120-1.

Second, when the environment data obtainer 140-1 of the UE 100-1 obtains the environment data, the association may be performed in the gNB 200. In this case, for example, the environment data obtainer 140-1 obtains the learning data from the data collector A1 and generates environment data in response to obtaining the learning data. The environment data obtainer 140-1 transmits the learning data and the environment data to the gNB 200 via the transmitter 120-1. The controller 230 of the gNB 200 associates the environment data with the learning data.

Third, when the environment data obtainer 240 in the gNB 200 obtains the environment data, the association may be performed in the gNB 200. In this case, the data collector A1 (controller 130-1) of the UE 100-1 transmits the learning data used in the UE 100-1 to gNB 200 via the transmitter 120-1. Then, the controller 230 of the gNB 200 receives the learning data from the receiver 220, receives the environment data from the environment data obtainer 240, and associates the environment data with the learning data.

As described above, the gNB 200 obtains the learning data of the UE 100-1 and the environment data of the UE 100-1 which are associated with each other.

Then, the gNB 200 transmits the associated learning data of the UE 100-1 and environment data of the UE 100-1 to the UE 100-2. In the UE 100-2 which has received the learning data of the UE 100-1 and the environment data of the UE 100-1, for example, the following processing is performed.

In other words, the receiver 110-2 of the UE 100-2 receives the learning data of the UE 100-1 and the environment data of the UE 100-1, and outputs the received learning data and environment data to the data collector A1. The data collector A1 (or the controller 230) determines whether to perform machine learning using the learning data of the UE 100-1 based on the environment data of the UE 100-1. When, as a result of check of the environment data, the environment in the environment data is (significantly) different from the environment of the UE 100-2, the data collector A1 may determine not to perform machine learning using the learning data of the UE 100-1. In this case, the data collector A1 may discard the learning data. Upon determining not to perform machine learning using the learning data in the UE 100-1, the data collector A1 may determine to perform machine learning using the learning data of the UE 100-1 in order to derive another learned model (for example, a third learned model) in the UE 100-2. In this case, the data collector A1 may output the learning data of the UE 100-1 to a part of the model learner A2 that derives the another learned model.

### (1.4) Environment Data

A specific example of the environment data will be described. The environment data may include at least any one selected from the group consisting of the following pieces of information:

### -Movement Speed Information Indicating the Movement Speed of the UE 100-1

For example, the UE 100-1 includes a speed sensor. The environment data obtainer 140-1 may be a speed sensor. The speed sensor can obtain the movement speed information of the UE 100-1.

### -Azimuth Information Indicating the Azimuth of the UE 100-1

For example, the UE 100-1 includes an azimuth sensor (for example, a gyro sensor or a geomagnetic sensor). The environment data obtainer 140-1 may be an azimuth sensor. The azimuth sensor can obtain azimuth information of the UE 100-1.

### -Transmission Power Information Indicating the Transmission Power of the UE 100-1

For example, the environment data obtainer 140-1 of the UE 100-1 can obtain the transmission power information by obtaining, from the transmitter 120-1, the transmission power used when the transmission signal is transmitted from the transmitter 120-1.

### -Position Information Indicating the Position of the UE 100-1

For example, the UE 100-1 includes a Global Navigation Satellite System (GNSS) receiver. The environment data obtainer 140-1 may include the GNSS receiver. The GNSS receiver may obtain position information indicating the position of the UE 100-1 based on a GNSS reception signal. The position information may be indicated by latitude and longitude. The position information may indicate a distance from the gNB 200. In this case, the GNSS receiver may obtain the position of the UE 100-1, and on the assumption that the position of the gNB 200 is already known, may obtain the distance between the gNB 200 and the UE 100-1 from the position of the UE 100-1 and the position of the gNB 200. For example, the position information may be indicated by altitude. The altitude may indicate a height from the ground. The altitude may indicate a height above sea level (i.e., elevation). For example, the altitude may be obtained by the GNSS receiver. For example, the altitude may be obtained by an altitude sensor in the UE 100-1. The altitude sensor may also be included in the environment data obtainer 140-1.

### -Field Density Information Indicating Field Density of the UE 100-1

The field density information is information indicating what the location of the UE 100-1 is like, such as whether the location of the UE 100-1 is a city or a rural area. For example, the UE 100-1 includes the GNSS receiver. The GNSS receiver may be included in the environment data obtainer 140-1. In the GNSS receiver, for example, map information is held in advance in a memory or the like. The GNSS receiver obtains field density information indicating the field density based on the obtained position of the UE 100-1 and the map information, for example.

### -Line-of-Sight Information Indicating Line-of-Sight or Non-Line-of-Sight of the First User Equipment

The line-of-sight information is, for example, information indicating whether a propagation path of radio signals from the UE 100-1 to the gNB 200 is line-of-sight (Light of sight (LOS)) or the propagation path of radio signals from the UE 100-1 to the gNB 200 is non line of sight (Non Light Of Sight ((NLOS)). As in the case of the field density information, the GNSS receiver may obtain the line-of-sight information based on the position of the UE 100-1 and the map information.

### -Timestamp Information

For example, the UE 100-1 includes a timer. The environment data obtainer 140-1 may include a timer. The timestamp information is obtained by the timer. The GNSS receiver included in the UE 100-1 may obtain the timestamp information. The timestamp information may include date information.

### Antenna Information Related to the Antenna of the UE 100-1

The antenna information may include the number of antenna ports of the antenna included in the UE 100-1. The antenna information may include an antenna angle of the antenna. The environment data obtainer 140-1 may obtain the antenna information by reading out the antenna information stored in the memory in the UE 100-1.

### -Type Information Indicating the Type of the UE 100-1

The type information is, for example, information indicating what type of UE the UE 100-1 is. The type information may include a smartphone, an Internet of Things (IoT) apparatus, a Vehicle to Everything (V2X) target apparatus, UE corresponding to an Integrated Access Backhaul (IAB), a model number, or a manufacturer identification number. The environment data obtainer 140-1 may obtain the type information by reading out the type information from the memory in the UE 100-1.

-Measurement Information that can be Measured from a Reception Signal Received by the UE 100-1

The measurement information may include measurable reception quality. The reception quality may be Reference Signal Received Power (RSRP), Reference Signal Received Quality (RSRQ), Signal to Interference plus Noise Ratio (SINR), or a path loss. The environment data obtainer 140-1 or the receiver 110-1 may obtain the measurement information by measuring the reception signal based on the reception signal received by the receiver 110-1.

### -A Key Performance Indicator (KPI) of Learning Data Reliability or a Reliability Index of Learning Data

The KPI or the reliability index is, for example, an index indicating the degree of accuracy required for the learning data. The KPI or the reliability index may be an index indicating a target of the learning data. For example, the environment data obtainer 140-1 may calculate the KPI or the reliability index based on the above-described measurement information. The KPI or the reliability index may be set based on an input from a user who uses the UE 100-1.

-Region Information Indicating a Region in which the UE 100-1 Exists

The region information is a Tracking Area Identity (TAI), a Registration Area (RA), a Public Land Mobile Network (PLMN), a Physical Cell Identity (PCI), or a Cell Global Identity (CGI). The TA includes one or a plurality of cells, and indicates an area in which the UE 100 in the RRC idle state can move without updating MME. The TAI indicates an identifier for distinguishing each TA from other TAs. The RA includes one or a plurality of cells, and is defined as a set of TAs. The PLMN indicates a range in which a telecommunications carrier can provide a service. The PCI indicates a cell identifier that distinguishes each cell from other cells.

The region information is broadcasted from the gNB 200 using broadcast information (SIB), for example. Thus, the region information may be obtained by the receiver 110-1 of the UE 100-1 receiving the region information, and the environment data obtainer 140-1 receiving the region information from the receiver 110-1.

### -Frequency Information Used by the UE 100-1

Frequency information used by the UE 100-1 may be included in the environment data. The environment data obtainer 140-1 of the UE 100-1 may obtain the frequency information from the receiver 110-1 and/or the transmitter 120-1. The frequency information may be indicated by an Absolute Radio Frequency Channel Number (AFRCN).

### -Learned Model Type Information Indicating the Type of the Learned Model Derived in the UE 100-1

The learned model type information includes, for example, information indicating what learning algorithm has been used to derive the learned model. For example, the learned model type information includes linear regression analysis, a decision tree, logistic regression, k-nearest neighbors algorithm, support vector machine, clustering, k-means clustering, principal component analysis, or a neural network. For example, since the learned model type information is stored in the memory of the UE 100-1, the environment data obtainer 140-1 can obtain the learned model type information by reading the learned model type information out from the memory.

### -Learned Model Configuration Information Indicating a Configuration of a Learned Model

The learned model configuration information includes, for example, information indicating the configuration of the learning model. Specifically, the learned model configuration information includes the number of stages of the neural network, or the number of neurons that can be supported (the number of neurons per stage). For example, since the learned model configuration information is stored in the memory of the UE 100-1, the environment data obtainer 140-1 can obtain the learned model configuration information by reading the learned model configuration information from the memory.

### -AI Identifier Information Indicating an AI-Specific Identifier.

The AI identifier information indicates, for example, the identifier of the AI used in the UE 100-1. The AI identifier information may be identifier information according to a purpose or an environmental condition, such as an AI for resting condition, an AI for low-speed movement, an AI for high-speed movement, or an AI for specific position. For example, since the identifier of the AI is stored in the memory of the UE 100-1, the environment data obtainer 140-1 can obtain the identifier by reading the identifier out from the memory.

### (1.5) Operation Example of First Operation Scenario

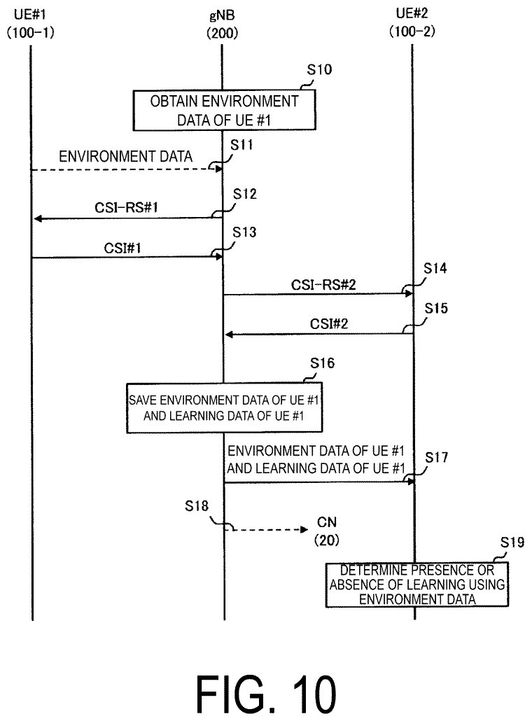

An operation example of a first operation scenario according to the first embodiment will be described. FIG. 10 is a flowchart illustrating the operation example of the first operation scenario.

When the operation example illustrated in FIG. 10 is performed, each of the UE 100-1 and the UE 100-2 is assumed to be performing model learning.

Before the operation example illustrated in FIG. 10 is performed, a message may be transmitted that includes instruction information for instructing association between learning data and environment data. For example, when the gNB 200 associates the environment data with the learning data of the UE 100-1, the core network apparatus may transmit, to the gNB 200, a message (for example, the first message) including instruction information for instructing the association. In this case, the core network apparatus may transmit, to the gNB 200, an NG message including the instruction information. When the UE 100-1 associates the environment data with the learning data of the UE 100-1, the gNB 200 may transmit, to the UE 100-2, a message (for example, a second message) including instruction information for instructing the association. In this case, the gNB 200 may transmit, to the UE 100-1, an RRC message, a MAC CE, or DCI including the instruction information.

In step S10, the gNB 200 obtains the environment data of the UE 100-1. The gNB 200 may receive, from the UE 100-1, the environment data obtained by the UE 100-1 (step S11).

In step S12, the gNB 200 transmits the CSI-RS #1 to the UE 100-1.

In step S13, the UE 100-1 measures the CSI based on the CSI-RS #1, and transmits the measurement result to the gNB 200 as CSI #1.

Note that the UE 100-1 performs model learning using the CSI-RS #1 and the CSI #1 as learning data to derive a learned model (e.g., the first learned model). The UE 100-1 transmits the learning data (CSI-RS #1 and CSI #1) of the UE 100-1 to the gNB 200. The UE 100-1 may transmit the learning data together with the CSI #1 (step S13). The UE 100-1 may transmit the learning data separately from the CSI #1.

In step S14, the gNB 200 transmits CSI-RS #2 to the UE 100-2.

In step S15, the UE 100-2 measures the CSI based on the CSI-RS #2, and transmits the measurement result to gNB 200 as CSI #2. The UE 100-2 also executes processing of performing model learning using the CSI-RS #2 and CSI #2 as learning data and deriving a learned model (for example, the second learned model).

In step S16, the gNB 200 associates the learning data of the UE 100-1 with the environment data of the UE 100-1. The gNB 200 saves the associated learning data and environment data in a memory of the gNB 200.

Note that, when association is performed in the UE 100-1, the UE 100-1 can obtain the learning data of the UE 100-1 upon obtaining the CSI #1 (step S13). Thus, when transmitting the CSI #1 (step S13) or after transmitting the CSI #1, the UE 100-1 may associate the learning data of the UE 100-1 with the environment data of the UE 100-1. Subsequently, the UE 100-1 transmits the associated learning data and environment data to the gNB 200.

In step S17, the gNB 200 transmits the associated learning data of the UE 100-1 and environment data of the UE 100-1 to the UE 100-2.

The gNB 200 may transmit the associated learning data of the UE 100-1 and environment data of the UE 100-1 to the core network apparatus of the CN 20 (step S18). The core network apparatus may transmit the learning data of the UE 100-1 and the environment data of the UE 100-1 to another UE through another gNB. This is because, like the UE 100-2, the another UE is also performing model learning using the learning data of the UE 100-1.

Note that the gNB 200 may check, for the UE 100-1 and the UE 100-2 (and the another UE), a use condition for using the learning data of the UE 100-1 in the UE 100-2 (and the another UE). The core network apparatus may check, with the UE 100-1, the UE 100-2, and the another UE, the use condition for the use of the learning data of the UE 100-1 in the UE 100-2 and the another UE. The use condition may be, for example, an antenna configuration of each UE, the type, model number, and/or manufacturer identification number of the UE. The gNB 200 or the core network apparatus may determine whether the learning data of the UE 100-1 is available in the UE 100-2 or the another UE based on the use condition obtained from each UE.

In step S19, the UE 100-2 determines whether to use the learning data of the UE 100-1 for machine learning based on the environment data of the UE 100-1. When determining to use the learning data of the UE 100-1 based on the environment data, the UE 100-2 uses the learning data of the UE 100-1 to perform machine learning to derive a learned model (for example, the second learned model).

### (1.6) Another Example of First Operation Scenario

In the first operation scenario, an example has been described in which the CSI-RS is used as a component included in the learning data, but the present disclosure is not limited thereto.

For example, the learning data may include at least any one selected from the group consisting of RSRP, RSRQ, SINR, and an output waveform of an AD converter, instead of the CSI-RS. RSRP, RSRQ, SINR, and the output waveform of the AD converter may be measured by using the CSI-RS and/or any other reception signal as a measurement target. The model learner A2 derives a learning model using, for example, the RSRP and the CSI as learning data. For example, the model inferrer A3 may obtain inference result data (CSI) by causing the RSRP measured from the partial CSI-RS to be input to the learning model as inference data.

The learning data may include a Bit Error Rate (BER) and/or a Block Error Rate (BLER) instead of the CSI-RS. The BER indicates the ratio of the number of erroneously received bits to the total number of transmitted bits. The BLER indicates the ratio of the number of erroneously received blocks to the total number of transmitted blocks. The receivers 110-1 and 110-2 may measure the BER (or BLER) based on the CSI-RS with the total number of transmission bits (or the total number of transmission blocks) being known. The data collector A1 may include, in the learning data, the BERs (or BLERs) received from the receivers 110-1 and 110-2, and output the learning data to the model learner A2.

The learning data may include the movement speed of the UE 100 instead of the CSI-RS. For example, the UE 100-1 includes a speed sensor, and the data collector A1 includes, in the learning data, the movement speed of the UE 100-1 obtained from the speed sensor, and outputs the learning data to the model learner A2.

### (2) Second Operation Scenario

A second operation scenario will be described. The description of a second operation scenario focuses mainly on differences from the first operation scenario.

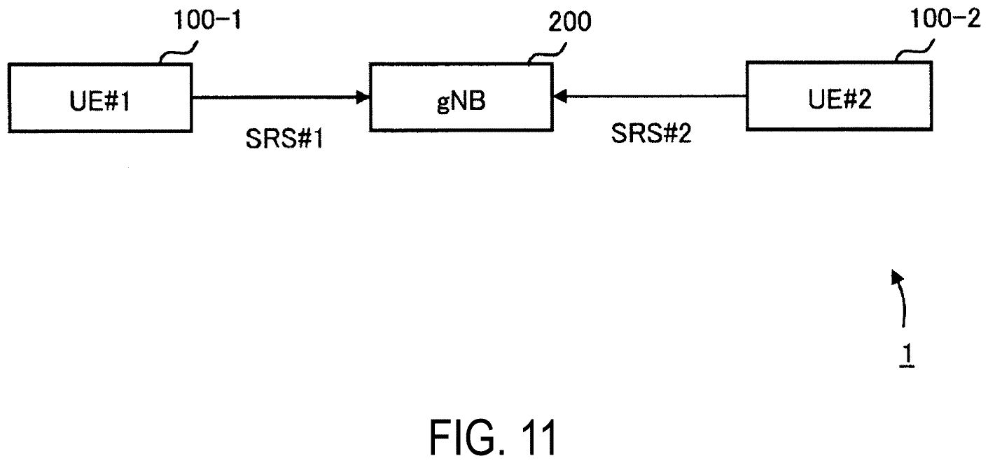

FIG. 11 is a diagram illustrating the second operation scenario according to the first embodiment.

As described above, the second operation scenario is an example in which the gNB 200 performs machine learning to derive learned models (for example, the first learned model and the second learned model). The second operation scenario will be described by use of an example of CSI feedback using the SRS. Note that, in the second operation scenario, a reference signal for estimating an uplink channel state needs to be transmitted from the UE 100-1 and the UE 100-2 and that a demodulation reference signal (DMRS) may be used instead of the SRS.

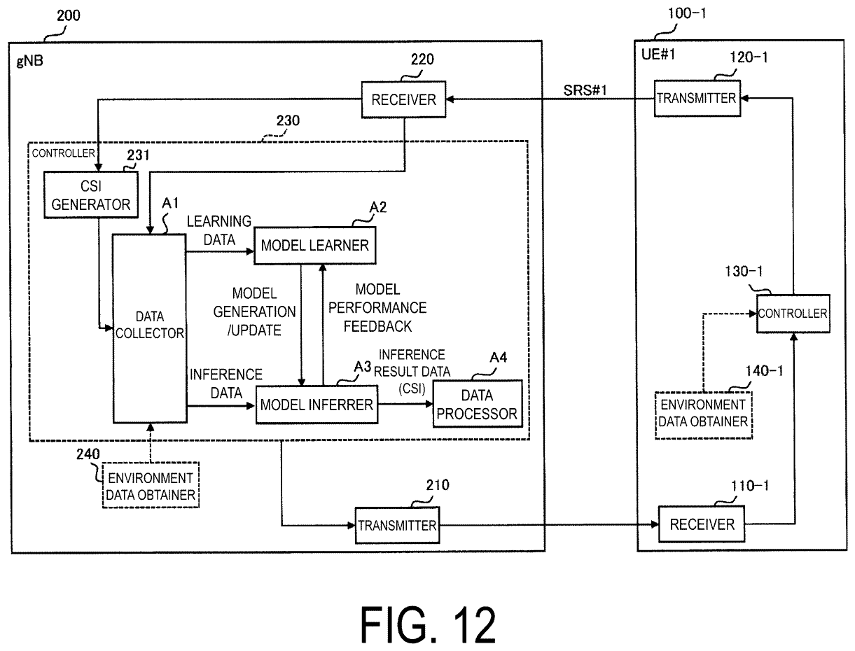

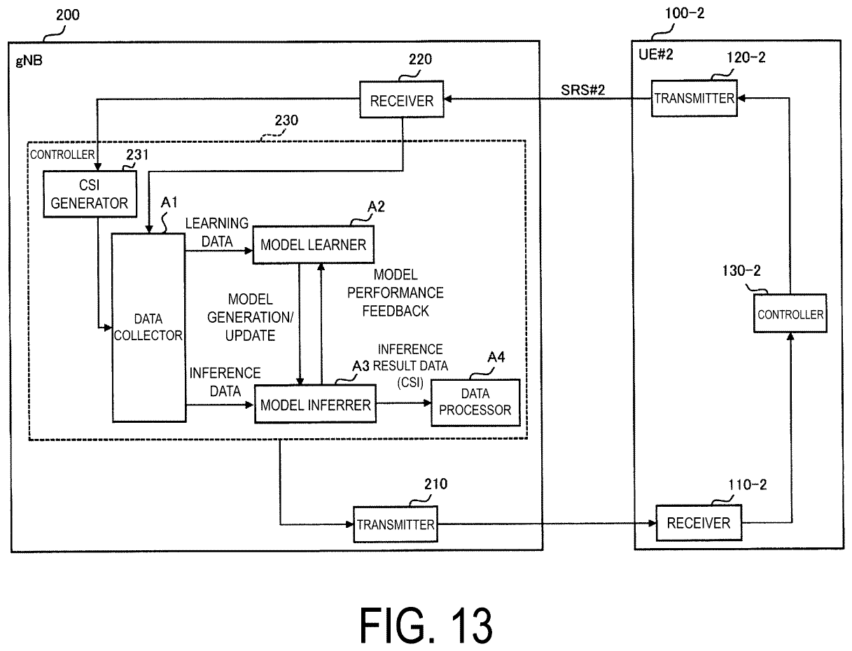

FIGS. 12 and 13 are diagrams illustrating configuration examples of the UE 100-1, the UE 100-2, and the gNB 200 in the second operation scenario according to the first embodiment. As illustrated in FIGS. 12 and 13, in the second operation scenario, the data collector A1, the model learner A2, the model inferrer A3, and the data processor A4 are installed in the gNB 200. Thus, the model learning and the model inference are performed in the gNB 200.

As illustrated in FIG. 12, the gNB 200 generates CSI from SRS #1 transmitted from the UE 100-1. Thus, the gNB 200 further includes a CSI generator 231. The CSI is used for, for example, uplink scheduling of the UE 100-1. The model learner A2 performs machine learning using the SRS #1 and the generated CSI as the learning data (for example, the first learning data) of the UE 100-1 to derive a learned model. Then, the model inferrer A3 inputs the partial SRS transmitted from the UE 100-1 to the derived learned model as inference data to obtain inference result data (CSI).

On the other hand, as illustrated in FIG. 13, in the gNB 200, the CSI generator 231 generates CSI from SRS #2 transmitted from the UE 100-2. The model learner A2 performs machine learning using the SRS #2 and the generated CSI as the learning data (for example, the second learning data) of the UE 100-2 to derive a learned model (for example, the second learned model). The model inferrer A3 inputs the partial SRS transmitted from the UE 100-2 to the derived learned model as inference data to obtain inference result data (CSI).

In the mobile communication system 1 installed as described above, in the second operation scenario, the environment data may be obtained in the gNB 200 as in the first operation scenario. The environment data may be obtained in the UE 100-1. In other words, the gNB 200 may be provided with the environment data obtainer 240. The UE 100-1 may be provided with the environment data obtainer 140-1. Upon obtaining the environment data, the environment data obtainer 140-1 of the UE 100-1 transmits the obtained environment data to the gNB 200 via the controller 130-1 and the transmitter 120-1.

In the second operation scenario, the gNB 200 associates the environment data of the UE 100-1 with the learning data of the UE 100-1. The association may be performed in the data collector A1 (or the controller 230). The association may be performed in the environment data obtainer 240. When the association is performed in the environment data obtainer 240, the data collector A1 outputs the learning data of the UE 100-1 to the environment data obtainer 240. Then, the environment data obtainer 240 associates the learning data and the environment data, and outputs the associated data to the data collector A1 (or the controller).

In the second operation scenario, when performing machine learning using the learning data of the UE 100-2, the gNB 200 can determine, based on the environment data of the UE 100-1, whether to perform the machine learning using the learning data of the UE 100-1. The gNB 200 performs, for example, the processing as described below.

In other words, the data collector A1 obtains the environment data of the UE 100-1 from the environment data obtainer 240. The data collector A1 obtains the environment data transmitted from the UE 100-1 via the receiver 220. By using the learning data of the UE 100-1 based on the environment data of the UE 100-1, the data collector A1 (or the controller 230) determines whether to perform machine learning for deriving a learned model using the learning data of the UE 100-2. As in the first operation scenario, upon determining not to perform the machine learning using the learning data of the UE 100-1 based on the environment data, the data collector A1 may discard the learning data of the UE 100-1. Even upon determining not to perform the machine learning using the learning data of the UE 100-1, the data collector A1 may determine to perform the machine learning using the learning data of the UE 100-1 in order to derive another learned model (for example, the third learned model) using the learning data of the UE 100-2. In this case, the data collector A1 may output the learning data of the UE 100-1 to a part of the model learner A2 that derives another learned model.

In this way, in the second operation scenario, the learning data of the UE 100-1 is associated with the environment data of the UE 100-1. Accordingly, for example, while performing machine learning using the learning data of the UE 100-2, the gNB 200 can determine, based on the environment data of the UE 100-1, whether to use the learning data of the UE 100-1 for the machine learning. As a result, the gNB 200 can avoid using, for machine learning, learning data that is not suitable for the environment of the UE 100-2, and the machine learning technology can be appropriately utilized in the mobile communication system 1.

### (2.1) Operation Example of Second Operation Scenario

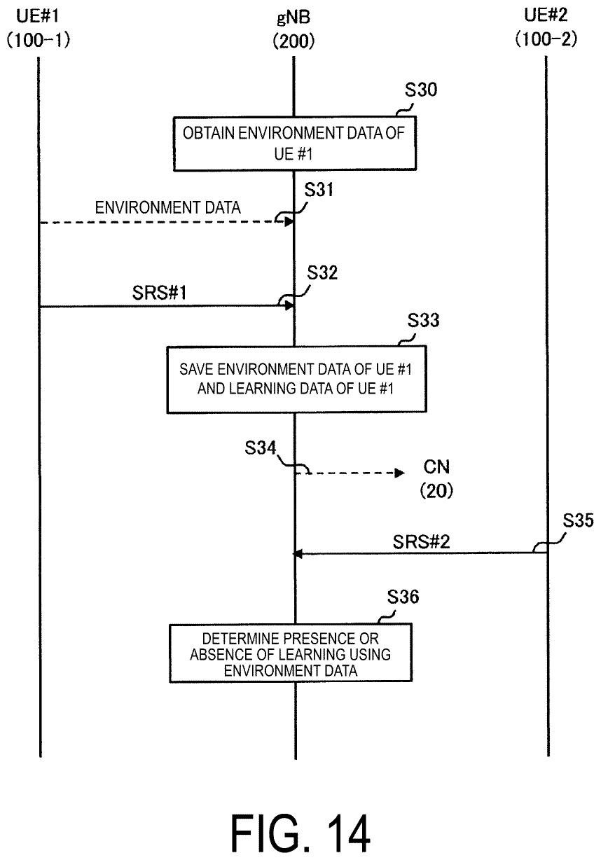

An operation example of the second operation scenario example according to the first embodiment will be described. FIG. 14 is a diagram illustrating the operation example of the second operation scenario.

Note that, while the operation example illustrated in FIG. 14 is being performed, the gNB 200 is assumed to be performing model learning for deriving a learning model.

As in the case of the first operation scenario, before the operation example illustrated in FIG. 14 is performed, the core network apparatus may transmit, to the gNB 200, a message including instruction information for instructing association between the learning data and the environment data.

In step S30, the gNB 200 obtains the environment data of the UE 100-1. The gNB 200 may obtain the environment data by receiving the environment data from the UE 100-1 (step S31). The gNB 200 may obtain the environment data by generating the environment data of the UE 100-1 based on the reception signal received from the UE 100-1. In this case, the gNB 200 may obtain the environment data by using the functions of the SON and/or the MDT, as in the first operation scenario.

In step S32, the UE 100-1 transmits (feeds back) the SRS #1 to the gNB 200. The gNB 200 generates CSI #1 from the SRS #1, and performs model learning from the learning data (SRS #1 and CSI #1) of the UE 100-1.

In step S33, the gNB 200 associates the learning data of the UE 100-1 with the environment data of the UE 100-1. The gNB 200 saves the associated learning data and environment data in the memory.

In the step S34, the gNB 200 may transmit the associated learning data of the UE 100-1 and environment data of the UE 100-1 to the core network apparatus. The core network apparatus may transmit the learning data of the UE 100-1 and the environment data of the UE 100-1 to another UE via another gNB.

In step S35, the UE 100-2 transmits the SRS #2 to the gNB 200. The gNB 200 generates CSI #2 from the SRS #2, and performs machine learning based on the learning data (SRS #1 and CSI #2) of the UE 100-2 to derive a learned model (for example, the second learned model).

In step S36, based on the environment data of the UE 100-1, the gNB 200 determines whether to use the learning data of the UE 100-1 in machine learning for deriving a learned model (e.g., the second learned model) using the learning data of the UE 100-2. Upon determining to use the learning data of the UE 100-1, the gNB 200 performs machine learning using the learning data of the UE 100-1 to derive a learned model using the learning data of the UE 100-2.

### (2.2) Another Example of Second Operation Scenario

In the second operation scenario, an example has been described in which the SRS is used as a component included in the learning data, but the present disclosure is not limited thereto. For example, as in the first operation scenario, the learning data may include at least any one selected from the group consisting of the RSRP, the RSRQ, the SINR, the output waveform of the AD converter, the BER, the BLER, and the movement speeds of the UE 100-1 and the UE 100-2. The RSRP, the RSRQ, the SINR, the output waveform of the AD converter, the BER, and the BLER may be measured by the receiver 220 of the gNB 200 based on the SRS. The gNB 200 may receive, from the UE 100-1 and the UE 100-2, the movement speeds measured by the speed sensors of the UE 100-1 and the UE 100-2.

### (3) Third Operation Scenario

A third operation scenario will be described. The third operation scenario will also be described with differences from the first operation scenario focused on.

As in the first operation scenario, the third operation scenario is a case where the UE 100-1 and the UE 100-2 perform machine learning to derive a learned model. However, in the third operation scenario, beam management is used.

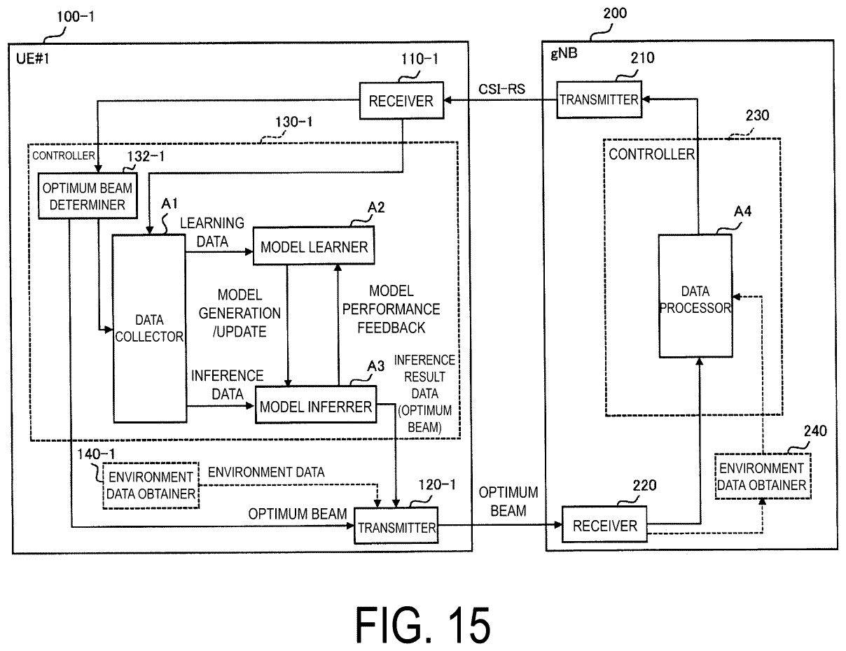

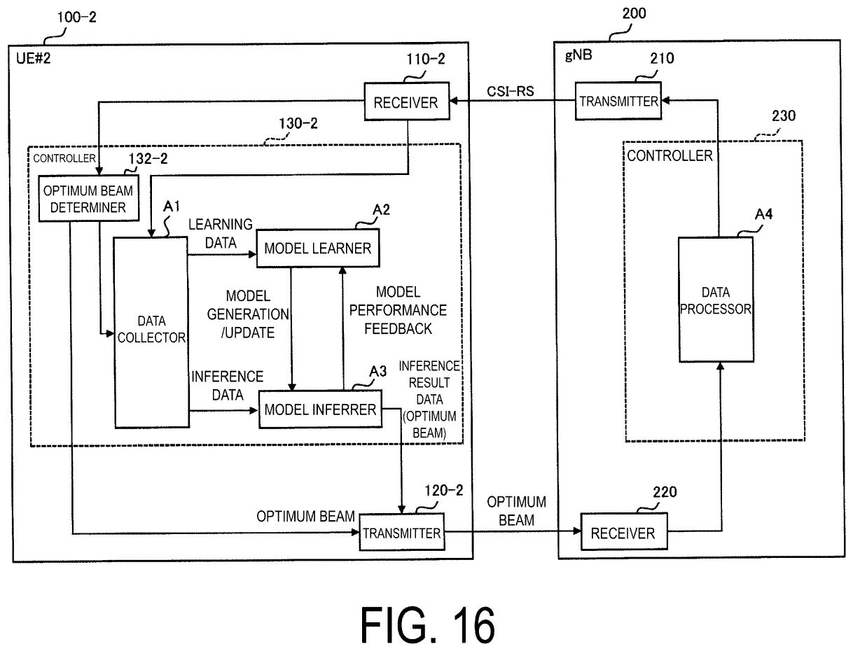

FIGS. 15 and 16 are diagrams illustrating configuration examples of the UE 100-1, the UE 100-2, and the gNB 200 in the third operation scenario according to the first embodiment. As illustrated in FIGS. 15 and 16, in the third operation scenario, the CSI-RS and the optimum beam among the beams transmitted from the gNB 200 are used as the learning data.

The gNB 200 uses a beamforming technology using a plurality of antenna ports (or a plurality of antenna elements) in order to compensate for a propagation loss in a transmission frequency band. The beamforming technology allows the gNB 200 to form a beam that provides a transmission signal with directivity to increase or reduce signal power in a specific direction. The gNB 200 can transmit the CSI-RS for each of the beams formed in different directions. By measuring the RSRP and the like from each CSI-RS, the UE 100 can select an optimum beam. As illustrated in FIGS. 15 and 16, the UE 100-1 and the UE 100-2 further include optimum beam determiners 132-1 and 132-2 in order to select the optimum beam.

The optimum beam determiner 132-1 of the UE 100-1 determines the optimum beam based on the reception quality of each CSI-RS received from the receiver 110-1. Hereinafter, one or more CSI-RSs received by the UE 100-1 may also be referred to as “CSI-RS #1”. The optimum beam determiner 132-1 performs the following processing, for example.

In other words, the optimum beam determiner 132-1 receives the reception quality (or measurement value) of each CSI-RS #1 from the receiver 110. The optimum beam determiner 132-1 receives, from receiver 110, resource information used for reception of each CSI-RS #1. The optimum beam determiner 132-1 obtains a CSI-RS resource indicator (CRI) from the resource information. The CRI is used to identify each CSI-RS. The CRI is associated with each beam. The optimum beam determiner 132-1 determines, for example, the CRI of the CSI-RS having the best reception quality as the optimum beam. The optimum beam determiner 132-1 outputs the determined CRI as the optimum beam.

Note that each beam needs to be identified by identifying each CSI-RS and that an indicator other than the CRI may be used.

The data collector A1 outputs the CSI-RS #1 and the optimum beam to the model learner A2 as the learning data (for example, the first learning data) of the UE 100-1. The model learner A2 performs machine learning using the CSI-RS #1 and the optimum beam to derive a learned model (for example, the first learned model).

The data collector A1 outputs the partial CSI-RS to the model inferrer A3 as inference data as in the first operation scenario. The model inferrer A3 causes the partial CSI-RS to be input to the learned model and outputs the optimum beam as inference result data.

Note that the optimum beam determiner 132-2 of the UE 100-2 determines the optimum beam based on the reception quality of each CSI-RS received from the receiver 110-2. The one or more CSI-RSs received by the UE 100-2 may also be referred to as “CSI-RS #2”. The optimum beam determiner 132-2 may determine the optimum beam by performing the processing which is the same as and/or similar to the processing of the optimum beam determiner 132-1 of the UE 100-1.

In the UE 100-2, the model learner A2 performs machine learning using the CSI-RS #2 and the optimum beam as the learning data (for example, the second learning data) of the UE 100-2 to derive a learned model (for example, the second learned model). The model inferrer A3 of the UE 100-2 uses the learned model to output inference result data (optimum beam) for the partial CSI-RS.

Also in the third operation scenario, any of the UE 100-1 and gNB 200 can associate the environment data with the learning data (for example, the first learning data) of the UE 100-1. Such association enables the UE 100-2, having received the environment data of the UE 100-1 and the learning data of the UE 100-1, to determine, based on the environment data, whether to perform machine learning using the learning data of the UE 100-1. As a result, the UE 100-2 can avoid using, for machine learning, learning data that is not suitable for the environment of the UE 100-2 (for example, the learning data of the UE 100-1), and the machine learning technology can be appropriately utilized in the mobile communication system 1.

### (3.1) Operation Example of Third Operation Scenario

In the third operation scenario, the UE 100-1 and the UE 100-2 derive learned models as in the first operation scenario. The third operation scenario differs from the first operation scenario only in the target learning data, and includes executing processing basically the same as, and/or similar to, that in the operation example of the first operation scenario (FIG. 10).

### (3.2) Another Example of Third Operation Scenario

In the third operation scenario, an example has been described in which the CSI-RS is used as a component included in the learning data, but the present disclosure is not limited to this.

For example, the learning data may include a Synchronization Signal Block (SSB) instead of the CSI-RS. The gNB 200 transmits the SSB at different timings for the respective beams based on the beamforming technology, and the UE 100-1 can determine the optimum beam by measuring each received SSB. For example, the UE 100-1 performs the processing as described below. In other words, the receiver 110-1 of the UE 100-1 outputs, to the optimum beam determiner 132-1, the measurement result of each SSB and an SSB index included in the SSB. The optimum beam determiner 132-1 identifies, based on the measurement result of each SSB, the SSB index of the SSB having the best reception quality. Since each SSB index is associated with each beam, the optimum beam determiner 132-1 can identify (or determine) the optimum beam by identifying the SSB index of the SSB having the best received power (or reception quality).

The learning data may include, instead of the CSI-RS, at least any one selected from the group consisting of the RSRP, the RSRQ, the SINR, and the output waveform of the AD converter as in the case of the first operation scenario. The CSI-RS and/or the SSB may also be the measurement target of the RSRP, the RSRQ, the SINR, and the output waveform of the AD converter.

The learning data may include the BER and/or the BLER instead of the CSI-RS as in the case of the first operation scenario.

The learning data may include the number of beams and/or the beam pattern instead of the CSI-RS. The number of beams and the beam pattern are included in, for example, the DCI or the broadcast information, and the UE 100-1 and the UE 100-2 can obtain the number of beams and the beam pattern by receiving the DCI or the broadcast information transmitted from the gNB 200.

When a plurality of beams are present, the learning data may include, instead of the CSI-RS, at least any one selected from the group consisting of the RSRP, the RSRQ, the SINR, and the output waveform of the AD converter.

The learning data may include the movement speed of the UE 100 instead of the CSI-RS as in the first operation scenario.

In the third operation scenario, the optimum beam has been described as being included in the learning data. For example, for the optimum beam, the time when the beam is measured and the time when the beam is selected may be taken into account. In other words, the time when the UE 100-1 and 100-2 obtain the measurement values of the beam (or a set of beams) is T1, and the time when the UE 100-1 and 100-2 select the optimal beam is T2. The UE 100-1 and 100-2 may set the beam selected at the time T2 as the optimum beam based on the measurement value obtained at the time T1.

### (4) Fourth Operation Scenario

A fourth operation scenario will be described. The fourth operation scenario will be described with differences from the first operation scenario focused on.

In the fourth operation scenario, the UE 100-1 and the UE 100-2 derive learned models as in the first operation scenario. In the fourth operation scenario, position information (Positioning accuracy enhancement) is used.

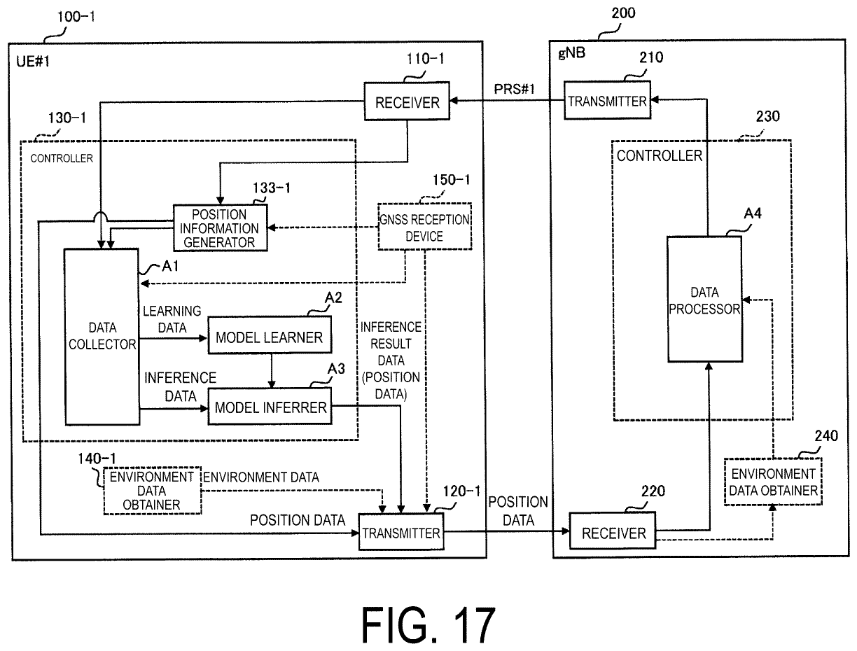

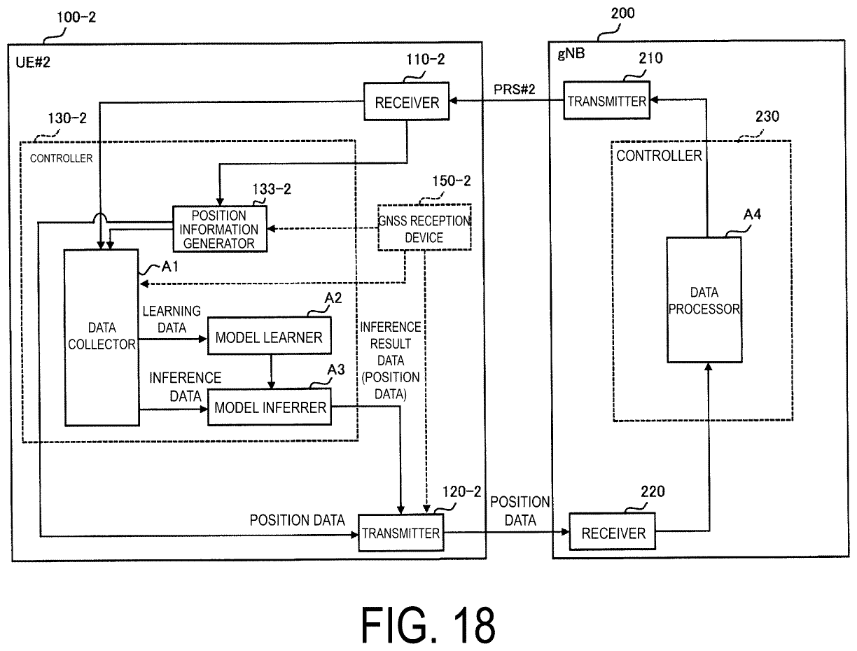

FIGS. 17 and 18 are diagrams illustrating configuration examples of the UE 100-1, the UE 100-2, and the gNB 200 in the fourth operation scenario according to the first embodiment. In the examples illustrated in FIGS. 17 and 18, a Positioning Reference Signal (PRS) and position data are used as learning data. The UEs 100-1 and 100-2 further include position information generators 133-1 and 133-2. For example, the position information generator 133-1 generates position information from the PRS by the processing as described below.

In other words, the receiver 110-1 of the UE 100-1 receives the PRS transmitted from the gNB 200 (hereinafter, the PRS received by the UE 100-1 may be referred to as “PRS #1”). The receiver 110-1 outputs the PRS #1 to the position information generator 133-1. The position information generator 133-1 generates the position information of the UE 100-1 based on the PRS #1. The position information generator 133-1 generates position information of the UE 100-1 by using, for example, Downlink Time Difference Of Arrival (DL-TDOA) as a positioning scheme. In this case, the position information generator 133-1 measures a time difference of arrival (a DL Reference Signal Time Difference (DL RSTD)) for the PRS and calculates the distance to the cell (or gNB) from the time difference of arrival. The position information generator 133-1 generates the position information of the UE 100-1 based on the distances to at least three cells (or gNBs). The position information generator 133-1 outputs the generated position information to the data collector A1 as position data.

Note that the position information generator 133-1 needs to use a positioning scheme capable of measuring the position of the UE 100-1 using a reception signal and that the position information generator 133-1 may obtain the position information of the UE 100-1 using a Downlink Angle-of-Departure (DL-AoD) or a Multi-Roundtrip Time (RTT). The DL-AoD is a positioning scheme in which the angle of departure (AoD) of the PRS #1 is calculated from the received power of the PRS #1, and the position information of the UE 100-1 is obtained from the intersection position in three directions. The multi-RTT is a positioning scheme for measuring the position of the UE 100-1 by measuring, for each cell, a round trip time from a time difference between transmission and reception and calculating distances (at least three distances) from the round trip time.

The position information generator 133-2 of the UE 100-2 is also the same as, and/or similar to, the position information generator 133-1 of the UE 100-1 except that the PRS received by the UE 100-2 (the PRS may hereinafter be referred to as “PRS #2”) is PRS #2.

The data collector A1 of the UE 100-1 outputs the PRS #1 and the position data of the UE 100-1 to the model learner A2 as learning data. The model learner A2 performs model learning using the PRS #1 and the position data of the UE 100-1 to derive a learned model (for example, the first learned model).

The data collector A1 of the UE 100-1 receives, from the receiver 110-1, the partial PRS received from the gNB 200 by the receiver 110-1, and outputs the partial PRS to the model inferrer A3 as inference data. The model inferrer A3 outputs an inference result (position data) for the partial PRS using the learned model.

The UE 100-2 is the same as, and/or similar to, the UE 100-1 except that the PRS received from the gNB 200 is the PRS #2.

Also in the fourth operation scenario, any of the gNB 200 and the UE 100-1 associates the environment data of the UE 100-1 with the learning data of the UE 100-1. Upon receiving the environment data of the UE 100-1 and the learning data of the UE 100-1, the UE 100-2 can determine whether to perform machine learning using the learning data of the UE 100-1 based on the environment data. As a result, the UE 100-2 can avoid using, for machine learning, learning data that is not suitable for the environment of the UE 100-2 (for example, the learning data of the UE 100-1), and the machine learning technology can be appropriately utilized in the mobile communication system 1.

### (4.1) Operation Example of Fourth Operation Scenario

In the fourth operation scenario, the UE 100-1 and the UE 100-2 derive learned models as in the first operation scenario. The fourth operation scenario differs from the first operation scenario only in the target learning data, and includes executing processing basically the same as, and/or similar to, that in the operation example of the first operation scenario (FIG. 10).

### (4.2) Another Example of Fourth Operation Scenario

In the fourth operation scenario, an example has been described in which the PRS is used as a component included in the learning data, but the present disclosure is not limited thereto.

For example, the learning data may include, instead of the PRS, positioning data obtained by a GNSS reception device 150-1. In this case, as illustrated in FIGS. 17 and 18, the UE 100-1 may further include a GNSS reception device 150-1, and the UE 100-2 may further include a GNSS reception device 150-2. The position information generator 133-1 may include the GNSS reception device 150-1, and the position information generator 133-2 may include the GNSS reception device 150-2. The GNSS reception device 150-1 outputs, to the position information generator 133-1 and the data collector A1, the position information based on the GNSS reception signal as the positioning data. The position information generator 133-1 generates position information of the UE 100-1 based on the positioning data. For example, the position information may be indicated by latitude and longitude. The position information may be information indicating a height from the ground. The position information generator 133-1 outputs the generated position information to the data collector A1 as position data. The data collector A1 of the UE 100-1 outputs the positioning data and the position data of the UE 100-1 to the model learner A2 as learning data. In this case, the data collector A1 of the UE 100-1 outputs, for example, partial positioning data to the model inferrer A3 as inference data.

The learning data may include any of the RSRP, the RSRQ, the SINR, and the output waveform of the AD converter instead of the PRS, as in the case of the first operation scenario. The measurement target of the RSRP, the RSRQ, the SINR, and the output waveform of the AD converter may be the PRS and/or any other reception signal.

The learning data may include the LOS or the NLOS instead of the PRS. For example, the position information generator 133-1 saves the map information in an internal memory and generates LOS or NLOS based on the position information of the UE 100-1 and the map information. The position information generator 133-1 outputs the generated LOS or NLOS to the data collector A1. The data collector A1 outputs, to the model learner A2, the LOS or the NLOS and the position information of the UE 100-1 as learning data.

The learning data may include, instead of the PRS, a measurement timing or likelihood applied to the measurement value (or a likelihood function applied to the measurement value). The measurement timing may be the reception timing of the PRS. The measurement timing may be a timing at which the position information generator 133-1 generates the position information of the UE 100-1. For example, the measurement value is an RSSI, and the likelihood applied to the measurement value indicates likelihood (or probability) for a distance calculated from the RSSI. For example, the position information generator 133-1 receives the RSSI from the receiver 110-1, calculates, from the RSSI, the distance to the gNB 200, and calculates the likelihood (or the likelihood function) from a probability distribution for the distance.

The learning data may include an RF fingerprint instead of the PRS. The RF fingerprint includes, for example, a cell ID and reception quality of a cell having the cell ID. For example, the RF fingerprint is obtained by the receivers 110-1 and 110-2 and output to the data collector A1.

The learning data may include, instead of the PRS, at least any one selected from the group consisting of the Angle of Arrival (AoA) of a reception signal, a reception level for each antenna, a reception phase for each antenna, and an Observed Time Difference Of Arrival (OTDOA) for each antenna. The AoA of the reception signal, the reception level for each antenna, the reception phase for each antenna, and the OTDOA for each antenna are obtained by, for example, the receivers 110-1 and 110-2 and output to the data collector A1.

The learning data may include, instead of the PRS, reception information of a beacon used in short-range wireless communication such as a wireless Local Area Network (LAN) such as Wi-Fi (trade name), or Bluetooth (trade name). The reception information of the beacon may be, for example, reception quality (such as RSRP or RSRQ) of the beacon.

The learning data may include the movement speed of the UE 100 instead of the PRS as in the first operation scenario.

### OTHER EMBODIMENTS

In the first embodiment described above, the supervised learning has mainly been described. However, the present disclosure is not limited thereto. For example, the first embodiment may be applied to the unsupervised learning or the reinforcement learning.

A program (information processing program) may be provided that causes a computer to execute each of the processing operations or each of the functions according to the embodiments described above. A program (e.g., mobile communication program) may be provided that causes the mobile communication system 1 to execute each of the processing operations or each of the functions according to the embodiments described above. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200.

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. The embodiments, operation examples, processing operations, or the like may be combined without being inconsistent.

### Supplementary Note

### Supplementary Note 1

A communication method in a mobile communication system including a first user equipment, a second user equipment, and a base station capable of communicating with the first user equipment and the second user equipment, the mobile communication system being capable of deriving a first learned model using first learning data and deriving a second learned model using second learning data, the communication method including:
associating, by any of the base station and the first user equipment, environment data indicating an environmental state of the first user equipment with the first learning data.

### Supplementary Note 2

The communication method according to Supplementary Note 1, further including:
deriving, by the first user equipment, the first learned model, and deriving, by the second user equipment, the second learned model.

### Supplementary Note 3

The communication method according to Supplementary Note 1 or Supplementary Note 2, wherein the associating includes:
transmitting, by the first user equipment to the base station, the environment data and the first learning data associated with each other when the first user equipment associates the environment data with the first learning data.

### Supplementary Note 4

The communication method according to any one of Supplementary Notes 1 to 3, wherein the associating includes:
transmitting, by the first user equipment, the first learning data to the base station when the base station associates the environment data with the first learning data.

### Supplementary Note 5

The communication method according to any one of Supplementary Notes 1 to 4, further including:
transmitting, by the base station, the first learning data and the environment data to the second user equipment; and
determining, by the second user equipment, whether to perform machine learning using the first learning data based on the environment data.

### Supplementary Note 6

The communication method according to any one of Supplementary Notes 1 to 5, wherein the determining includes:
determining, by the second user equipment, to perform machine learning using the first learning data to derive a third learned model when determining not to perform machine learning using the first learning data.

### Supplementary Note 7

The communication method according to any one of Supplementary Notes 1 to 6, wherein the associating includes:
generating, by the first user equipment, the environment data in response to obtaining the first learning data; and
transmitting, by the first user equipment, the environment data to the base station.

### Supplementary Note 8

The communication method according to any one of Supplementary Notes 1 to 7, wherein the associating includes:
transmitting, by the first user equipment to the base station, an environmental condition request for an environmental condition desired by the first user equipment; and
generating, by the base station, the environment data based on the environmental condition request.

### Supplementary Note 9

The communication method according to any one of Supplementary Notes 1 to 8, further including:
deriving, by the base station, the first learned model and the second learned model.

### Supplementary Note 10

The communication method according to any one of Supplementary Notes 1 to 9, further including:
determining, by the base station, whether to perform machine learning using the first learning data to derive the second learned model, based on the environment data, wherein the associating comprises associating, by the base station, the first learning data with the environment data.

### Supplementary Note 11

The communication method according to any one of Supplementary Notes 1 to 10, wherein the determining includes:
determining, by the base station, to perform machine learning using the first learning data to derive a third learned model when determining not to perform machine learning using the first learning data to derive the second learned model.

### Supplementary Note 12

The communication method according to any one of Supplementary Notes 1 to 11, further including:
checking, by the base station or a core network apparatus, with the first user equipment and the second user equipment, a use condition for use of the first learning data in the second user equipment.

### Supplementary Note 13

The communication method according to any one of Supplementary Notes 1 to 12, further including:
transmitting, by a core network apparatus to the base station, a first message including instruction information instructing association of the environment data with the first learning data when the base station associates the environment data with the first learning data, and transmitting, by the base station to the first user equipment, a second message including the instruction information instructing association of the environment data with the first learning data when the first user equipment associates the environment data with the first learning data.

### REFERENCE SIGNS

1: Mobile communication system
100 (100-1, 100-1): UE
110 (110-1, 110-2): Receiver
120 (120-1, 120-2): Transmitter
130 (130-1, 130-2): Controller
131-1, 131-2: CSI generator
132-1, 132-2: Optimum beam determiner
133-1, 133-2: Position information generator
140-1: Environment data obtainer
150-1, 150-2: GNSS reception device
200: gNB
210: Transmitter
220: Receiver
230: Controller
231: CSI generator
240: Environment data obtainer
A1: Data collector
A2: Model learner
A3: Model inferrer
A4: Data processor

1. A communication method in a mobile communication system comprising a first user equipment, a second user equipment, and a network node capable of communicating with the first user equipment and the second user equipment, the mobile communication system being capable of deriving a first learned model using first learning data and deriving a second learned model using second learning data, the communication method comprising:
associating, by any of the network node and the first user equipment, environment data indicating an environmental state of the first user equipment with the first learning data.

2. The communication method according to claim 1, further comprising:
deriving, by the first user equipment, the first learned model, and deriving, by the second user equipment, the second learned model.

3. The communication method according to claim 2, wherein the associating comprises:
transmitting, by the first user equipment to the network node, the environment data and the first learning data associated with each other when the first user equipment associates the environment data with the first learning data.

4. The communication method according to claim 2, wherein the associating comprises:
transmitting, by the first user equipment, the first learning data to the network node when the network node associates the environment data with the first learning data.

5. The communication method according to claim 3, further comprising:
transmitting, by the network node, the first learning data and the environment data to the second user equipment; and
determining, by the second user equipment, whether to perform machine learning using the first learning data, based on the environment data.

6. The communication method according to claim 5, wherein the determining comprises:
determining, by the second user equipment, to perform machine learning using the first learning data to derive a third learned model when determining not to perform machine learning using the first learning data.

7. The communication method according to claim 4, wherein the associating comprises:
generating, by the first user equipment, the environment data in response to obtaining the first learning data; and
transmitting, by the first user equipment, the environment data to the network node.

8. The communication method according to claim 1, wherein the associating comprises:
transmitting, by the first user equipment to the network node, an environmental condition request for an environmental condition desired by the first user equipment; and
generating, by the network node, the environment data based on the environmental condition request.

9. The communication method according to claim 1, further comprising:
deriving, by the network node, the first learned model and the second learned model.

10. The communication method according to claim 9, further comprising:
determining, by the network node, whether to perform machine learning using the first learning data to derive the second learned model, based on the environment data, wherein the associating comprises associating, by the network node, the first learning data with the environment data.

11. The communication method according to claim 10, wherein the determining comprises:
determining, by the network node, to perform machine learning using the first learning data to derive a third learned model when determining not to perform machine learning using the first learning data to derive the second learned model.

12. The communication method according to claim 2, further comprising:
checking, by the network node or a core network apparatus, with the first user equipment and the second user equipment, a use condition for use of the first learning data in the second user equipment.

13. The communication method according to claim 1, further comprising:
transmitting, by a core network apparatus to the network node, a first message comprising instruction information instructing association of the environment data with the first learning data when the network node associates the environment data with the first learning data, and transmitting, by the network node to the first user equipment, a second message comprising the instruction information instructing association of the environment data with the first learning data when the first user equipment associates the environment data with the first learning data.

14. A user equipment in a mobile communication system comprising the user equipment, another user equipment, and a network node capable of communicating with the user equipment and the another user equipment, the mobile communication system being capable of deriving a first learned model using first learning data and deriving a second learned model using second learning data, the user equipment comprising:
a controller configured to associate environment data indicating an environmental state of the user equipment with the first learning data.

15. A network node in a mobile communication system comprising a user equipment, another user equipment, and the network node capable of communicating with the user equipment and the another user equipment, the mobile communication system being capable of deriving a first learned model using first learning data and deriving a second learned model using second learning data, the network node comprising:
a controller configured to associate environment data indicating an environmental state of the user equipment with the first learning data.
